(19) United States
(12) Patent Application Publication
(10) Pub. No.: US 2015/0192225 A1
(43) Pub. Date: Jul. 9, 2015

(54) INTERLOCKING LINE BLOCK ASSEMBLY

(71) Applicant: Kirkhill-TA Co., Valencia, CA (US)

(72) Inventor: Toan Vo, Castaic, CA (US)

(21) Appl. No.: 14/591,771

(22) Filed: Jan. 7, 2015

Related U.S. Application Data
(60) Provisional application No. 61/924,640, filed on Jan. 7, 2014.

(51) Int. Cl. F16L 3/10; B23P 19/10; B23P 19/04; F16L 3/223

(52) U.S. Cl. CPC F16L 3/1091; F16L 3/2235; B23P 19/10; B23P 19/04

(57) ABSTRACT

Apparatus, systems, and methods related to an interlocking line block assembly that has a first block portion and a second block portion, each with an outer end surface, an inner end surface defining a plurality of concave receptacles, a plurality of side surfaces extending between the inner end surface and the outer end surface, at least one of the side surfaces having a retention member, and an aperture extending between the inner end surface and the outer end surface. A spacer projects from the a block support of the second block portion and through the aperture of the second block portion, the spacer configured to be slidably received within the aperture of the first block portion when the first block portion is mated with the second block portion.

### CROSS-REFERENCE TO RELATED APPLICATION

This application hereby claims priority to U.S. Provisional Patent Application No. 61/924,640, titled “Interlocking Line Block Assembly,” filed Jan. 7, 2014, which is incorporated herein in its entirety by reference thereto.

### TECHNICAL FIELD

The present invention is directed toward line support devices, including line support blocks useable for securing selected cables, wires, conduits, tubes, rods, or other lines to a supporting structure.

### BACKGROUND

Aircraft and other vehicles include many cables, wires, tubes, conduits, cords, and other lines extending through the vehicle. These lines are typically supported on the frame or other support structures in the vehicle. Clamps, ties, brackets, and line support blocks have been used to help manage and organize the lines and to securely retain the lines in a selected position within the vehicle. Conventional line support devices each experience drawbacks, which can include insufficient usability, manufacturing inefficiency, elevated cost, and/or limited versatility.

### SUMMARY

The present invention provides an interlocking line support block assembly that overcomes drawbacks experienced in the prior art and that provides additional benefits. As an example, at least one aspect of the present technology provides an interlocking block assembly comprising a first block portion having a first outer end surface, a first inner end surface defining a plurality of concave receptacles, a plurality of first side surfaces extending between the first inner end surface and the first outer end surface, at least one of the first side surfaces having a first retention member, and a first aperture extending between the first inner end surface and the first outer end surface, the first aperture spaced apart from the first side surfaces. The interlocking line block assembly further includes a second block portion having a second outer end surface, a second inner end surface defining a plurality of concave receptacles, a plurality of second side surfaces extending between the second inner end surface and the second outer end surface, at least one of the second side surfaces having a second retention member configured to releasably mate with the first retention member of the first block portion, thereby releasably mating the first block portion with the second block portion, and a second aperture extending between the second inner end surface and the second outer end surface, the second aperture spaced apart from the second side surfaces. A first block support is coupled to the first outer end surface, and a second block support is coupled to the second outer end surface. A spacer projects from the second block support, through and beyond the second aperture, and the spacer is configured to be slidably received within the first aperture when the first block portion is mated with the second block portion.

Another aspect of the present technology provides an interlocking line block assembly, comprising an upper portion having an upper support member, an upper flexible body projecting from the upper support member, the upper flexible body comprising an upper retention member and an upper line-receiving receptacle, and an aperture extending through the upper flexible body. The interlocking line block assembly further includes a lower portion having a lower support member, a lower flexible body projecting from the lower support member, the lower flexible body comprising a lower retention member configured to mate with the upper retention member, and a lower line-receiving receptacle, and a spacer projecting from the lower support member, the spacer configured to be slidably received within the aperture of the upper flexible body when the upper retention member is mated with the lower retention member.

Another aspect of the present technology provides an interlocking line block assembly, comprising a first block portion having a first support member and a first flexible body projecting from the first support member, the first flexible body comprising a first line-engaging portion spaced apart from the first support member, and the first flexible body comprising a male retention member. The interlocking line block assembly further includes a second block portion separably connectable to the first block portion and having a second support member spaced apart from the first support member, a second flexible body projecting from the second support member and being aligned and substantially co-planar with the first flexible body. The first and second body portions are positioned between the first and second support members, and the second flexible body includes a second line-engaging portion spaced apart from the second support member and positionable immediately adjacent to the first line engage portion of the first flexible body portion. The second flexible body includes a female retention member configured to mate with the male retention member to releasably hold the first and second flexible body portions together. A spacer is connected to the first and second block portions and extends between the first and second support members, the spacer being sized to block the first and second support members from moving closer to each other than a fixed distance corresponding to a length of the spacer thereby limiting a compression force between the first and second flexible body portions when the male and female retention members are releasably engaged with each other.

Another aspect of the present technology provides a method of retaining a line in an interlocking line block assembly, the method comprising providing a first block portion having a first support member, a first flexible body projecting from the first support member, the first flexible body comprising a first retention member and a first line-receiving receptacle, and an aperture extending through the first flexible body. The method further includes providing a second block portion having a second support member, a second flexible body projecting from the second support member, the second flexible body comprising a second retention member and a lower line-receiving receptacle, and a spacer projecting from the second support member. The method further includes disposing the line within the first line-receiving receptacle and mating the first block portion with the second block portion such that the second line-receiving receptacle engages the line disposed within the first line-receiving receptacle, wherein the spacer is slidably received within the aperture of the first flexible body and the first retention member is releasably mated with the second retention member.

### BRIEF DESCRIPTION OF THE DRAWINGS

FIG. 1A is a perspective view of an interlocking line support block assembly in accordance with an embodiment of the present disclosure, wherein mating block support portions are shown in a disengaged position.

FIG. 1B is a perspective view of the interlocking line support block assembly of FIG. 1A with the mating block support portions shown in an engaged, locked position.

FIG. 2 is an enlarged perspective view of an end portion of the interlocking line support block assembly of FIG. 1A, with the mounting, anti-compression tubes not shown for purposes of clarity.

FIG. 3A is a perspective view of the interlocking line support block assembly of FIG. 1A substantially in the disengaged position.

FIG. 3B is a perspective view of the interlocking line support block assembly of FIG. 1A in an intermediate position.

FIG. 3C is a perspective view of the interlocking line support block assembly of FIG. 1A in the engaged, locked position.

FIG. 4 is an isometric view of an interlocking line support block assembly in accordance with another embodiment of the present disclosure with mating block support portions shown in a disengaged position.

FIG. 5A is a perspective view of the interlocking line support block assembly of FIG. 4 substantially in an intermediate position.

FIG. 5B is a perspective view of the interlocking line support block assembly of FIG. 4 in an engaged, locked position.

### DETAILED DESCRIPTION

The present disclosure describes releasable, interlocking line support block assemblies in accordance with certain embodiments of the present invention. Several specific details of embodiments are set forth in the following description and Figures to provide a thorough understanding of the embodiments. One skilled in the art, however, will understand that the present invention may have additional embodiments, and that other embodiments of the invention may be practiced without several of the specific features described below. Further, one skilled in the art will recognize that the interlocking line support block assemblies described herein could be configured in many different arrangements and embodiments. Such variations of the present disclosure may be utilized without deviating from the spirit and scope of the present invention. The various embodiments set forth below are described and shown with a level of detail to provide a thorough understanding of the disclosure. Other structures and systems that may be associated with securing mechanisms have not been fully discussed to enable a clearer presentation of embodiments of this disclosure.

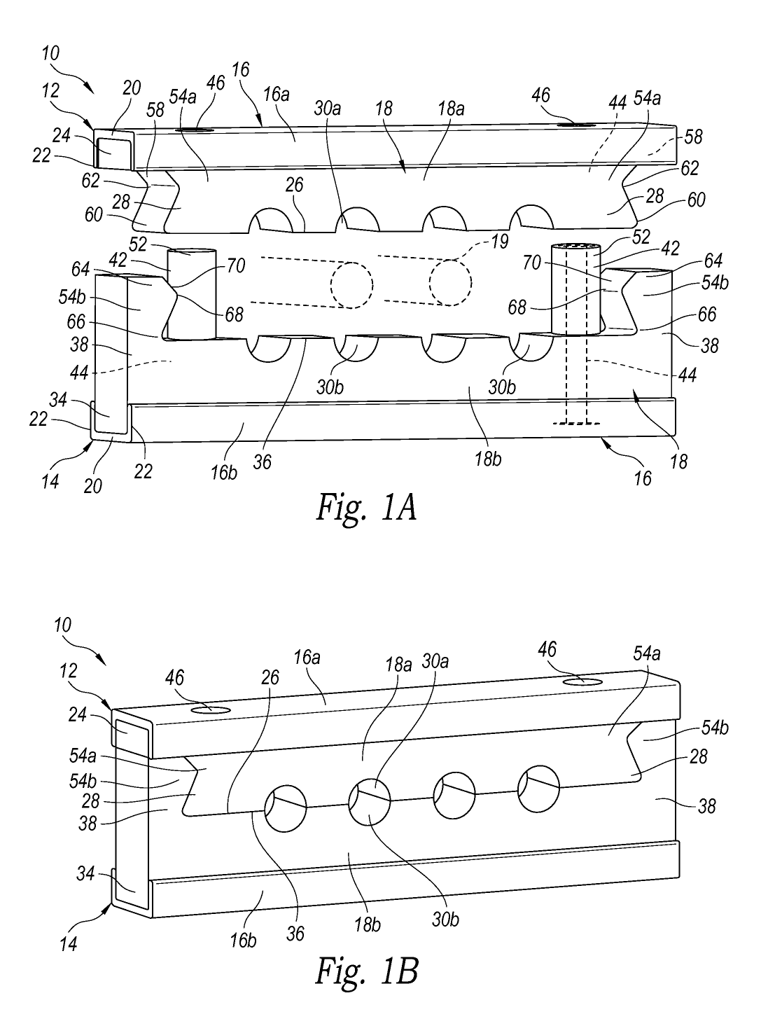

FIGS. 1A and 1B are perspective views of an interlocking line block assembly 10 in accordance with an embodiment of the present disclosure. The illustrated line block assembly 10 has interlocking upper and lower line block portions 12 and 14 configured to releasably capture selected lines 19 (shown in Phantom lines in FIG. 1A), such as cables, wires, conduits, tubes, rods, or other lines, therebetween. The line block assembly 10 can capture the selected lines 19 to form a preassembly, and the preassembly of the line block assembly 10 and selected lines 19 can be fastened or otherwise attached as a unit to a support structure, such as during manufacture or repair of an aircraft, space vehicle, truck, train, car, other land vehicle, ship, submarine, or other marine vehicle.

The embodiment of the line block assembly 10 is described herein for purposes of illustration with reference to the relative spatial orientation of the line block assembly as shown in the figures. The directional references regarding upper, lower, left, right, etc., however, are used to describe the assembly in the orientation as illustrated for ease of understanding. The directional orientation shown and described herein is not intended to limit the structure of the line block assembly 10. The line block assembly 10 can be oriented in spatial orientations different than those shown in the figures.

Each of the upper and lower line block portions 12 and 14 include a substantially rigid or stiff block support 16 connected to and supporting a flexible body portion 18. Each block support 16 in the illustrated embodiment is a rigid U-channel having a web 20 and a pair of opposing sidewalls 22 projecting away from the web 20. The block support 16 can be made of metal, plastic, carbon fiber, or other sufficiently rigid or stiff material. Each block support 16 captures the respective body portion 18 between the sidewalls 22 and against the web 20 so as to securely retain the block support 16 and body portion 18 together as a unit. The body portions 18 of the illustrated embodiment are made of flexible and partially compressible material, such as rubber, foam, urethanes, cork, etc. The body portions 18 are configured to engage, capture, and securely hold the lines 19 without crushing, creasing, crimping, or otherwise damaging the lines 19 between the body portions 18.

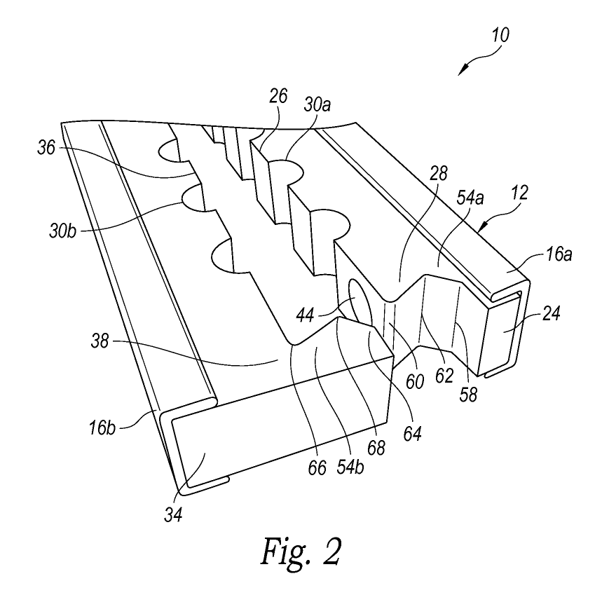

As seen in FIGS. 1A, 1B and 2, the upper portion 12 of the line block assembly 10 has an upper block support 16a fixed to an upper end portion 24 of an upper body portion 18a. The upper body portion 18a has a lower end portion 26 spaced apart from the block support 16a, and opposing side portions 28 spanning between the upper and lower end portions 24 and 26. The lower end portion 26 has a plurality of contoured line-receiving receptacles 30a shaped and sized to receive and retain selected lines 19. In the illustrated embodiment, the line-receiving receptacles 30a are concave, semi-cylindrical receptacles. In other embodiments, the line-receiving receptacles 30a can have different shapes and/or different sizes.

The lower portion 14 of the line block assembly 10 has a lower block support 16b fixed to a lower end portion 34 of the lower body portion 18b. The lower body portion 18b has an upper end portion 36 spaced apart from the block support 16b and configured to engage the lower end portion 26 of the upper body portion 18a. The lower body portion 18b also has opposing side portions 38 spanning between the upper and lower end portions 36 and 34. The opposing side portions 38 are configured to releasably mate with the side portions 28 of the upper body portion 18a to securely and releasably hold the upper and lower body portions 18a and 18b together, as discussed in greater detail below.

The upper end portion 36 also has a plurality of contoured line-receiving receptacles 30b aligned with the line receiving receptacles 30a of the upper body portion and shaped and sized to receive the selected lines 19. The illustrated line-receiving receptacles 30b are also concave, semi-cylindrical receptacles substantially identical to the upper line-receiving receptacles 30a. In other embodiments, the line-receiving receptacles 30b can have different shapes and/or sizes, including shapes and/or sizes, different from the mating receptacles 30a of the upper body portion 18a. In another embodiment, the upper and lower body portions 18a and 18b can each have only a single contoured line-receiving receptacle 30a and 30b. In yet other embodiments, the upper end portion 36 and/or lower end portion 26 of the body portions 18b and 18a, respectively, may be configured with portions that receive and/or securely engage the lines 19 without providing dedicated receptacles for each line 19.

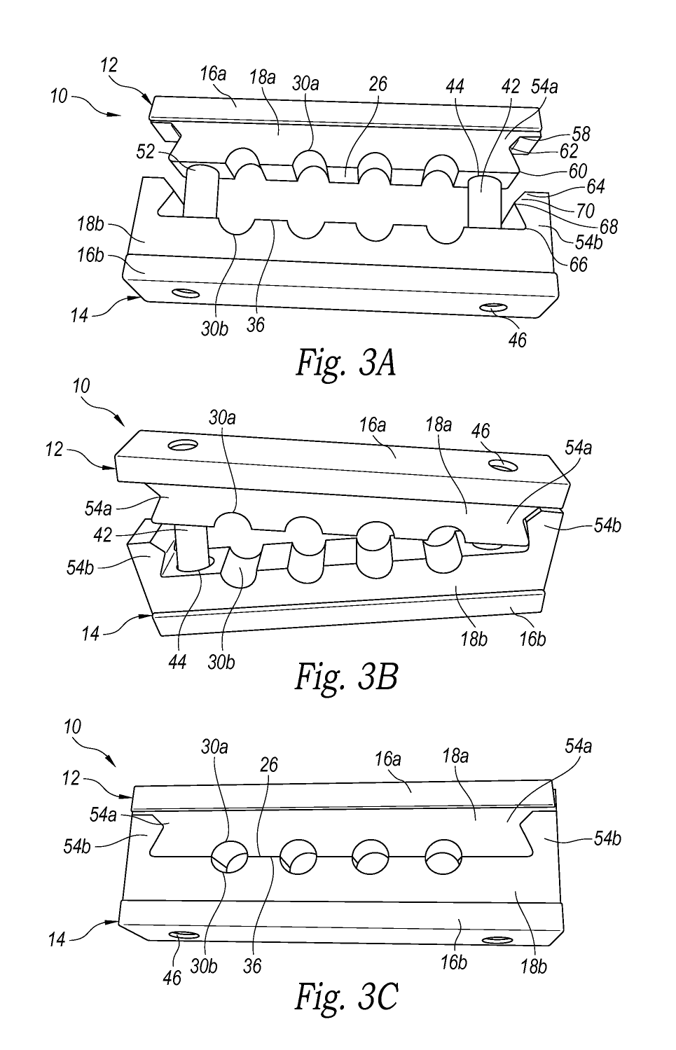

As shown in FIGS. 1A and 3B, the illustrated line block assembly 10 has a pair of spacers 42 spanning between the upper and lower block support members 16a and 16b. The illustrated spacers 42 are hollow, axially rigid tubes that extend through apertures 44 in the upper and lower body portions 18a and 18b and that are axially aligned with apertures 46 in the upper and lower block supports 16a and 16b. The spacers 42 each can be in contact with one end to the web 20 of the upper or lower block support 16a or 16b and extend through the respective body portion 18a and 18b. In other embodiments, the spacers 42 are not fixed to the block support 16a or 16b and can be held in position and in the apertures 44 via a friction fit with the corresponding body portion 18a or 18b. The free end 52 of the spacer 42 is positioned to axially align with and slidably extend through the apertures 44 of the other body portion 18b or 18a, so the free end 52 engages or is adjacent to the other block support 16b or 16a about the aperture 46 when the upper and lower portions 12 and 14 of the line block assembly 10 are joined together.

The spacers 42 are configured as anti-compression members that engage and block the upper and lower block supports 16a and 16b from moving too close to each other (i.e., less than the fixed distance corresponding to the length of the spacer), thereby preventing the upper and/or lower body portions 18a and 18b from being excessively compressed when the upper and lower portions 12 and 14 of the line block assembly 10 are joined together and/or fastened to a support structure. The spacers 42 also act to prevent the line block assembly 10 from exerting excessive compression forces on the lines 19 (FIG. 1A) when the assembly 10 is fastened to the support structure.

The hollow spacers 42 and the apertures 46 in the upper and lower block supports 16a and 16b define fastening channels through which bolts or other fastening devices can extend to fasten the line block assembly 10 to a selected support structure. The spacers 42 prevent the line block assembly 10 from being over-compressed by the fasteners during such installation, thereby protecting the lines 19 captured between the upper and lower portions 12 and 14 while securely retaining the lines 19 in the selected position and orientation.

The upper and lower portions 12 and 14 of the line block assembly 10 have deflectable interlocking retention members 54a and 54b on the side portions 38 of the body portions 18a and 18b. These interlocking retention members 54a and 54b releasably engage each other and hold the upper and lower portions 12 and 14 together in a closed position (FIG. 1B). The retention members 54a and 54b can be deflected or otherwise positioned to allow for disengagement of the mating retention members, so as to allow the upper and lower body portions 18a and 18b to be separated from each other and moved to a disengaged position, as shown in FIG. 1A.

The retention members 54a on the illustrated flexible upper body portion 18a have a generally chevron-shape or V-shape defined by upper and lower end portions 58 and 60 spaced laterally outward of a recessed central portion 62. Accordingly, the upper retention members 54a define the female portions of the interlocking retention members.

The retention members 54b on the flexible lower body portion 18b are the corresponding male portions of the interlocking retention members. The lower retention members 54b are configured with a mating generally chevron- or inverted V-shaped protrusion defined by upper and lower end portions 64 and 66 spaced laterally outward of a laterally projecting central portion 68. Accordingly, the laterally recessed central portion 62 of the upper body portion's retention members 54a form an undercut receiving area that receives the laterally projecting central portion 68 of the lower body portion's retention members 54b. Further, the lower end portion 66 of the lower body portion's retention member 54b defines an undercut region below the projecting central portion 68 that receives and engages the lower end portion 60 of the upper body portion's retention member 54a. Accordingly, when the upper and lower portions 12 and 14 are in the engaged position with the upper and lower retention members 54a and 54b in mating engagement with each other, the laterally projecting central portions 68 block the upper retention members 54a from moving vertically away from the lower retention member 54b. Simultaneously, the lower retention members 54b are blocked from moving vertically away from the upper retention members 54a by the lower end portions 60 of the upper retention members 54a.

While the illustrated upper retention members 54a have the female portions of the interlocking retention members and the lower retention members 54b have the corresponding male portions, other embodiments have the opposite configuration with the female portions defined by the lower retention members 54b and the male portions defined by the upper retention members 54a. Other embodiments can have the flexible, interlocking retention members defined by different interlocking, mating shapes, such as convex/concave shapes, or shapes with multiple undercuts, such as a W-shaped arrangement. The retention members 54a and 54b can be molded features, or they can be formed by cutting or other machining process.

The deflectable interlocking retention members 54a and 54b allows a user to position one or more lines 19 between the upper and lower body portions 18a and 18b in the line receiving receptacles 30a and 30b and then releasably lock the upper and lower portions 12 and 14 together via the interlocking retention members 54a and 54b. The resulting subassembly can be formed before the line block assembly 10 is fastened to a support structure, such as a vehicle frame or the like. This subassembly can then be easily moved to a desired location and fastened in place without having to worry about misalignment of the lines 19 captured in the line block assembly 10.

FIGS. 3A, 3B, and 3C are perspective views of the line support block assembly 10 in three different positions. In operation of at least one embodiment, when the upper and lower portions 12 and 14 of the line block assembly 10 are separated and in the disengaged position (FIG. 3A), one or more lines 19 are positioned in the line-receiving receptacles 30b of the lower portion 14 of the line block assembly 10. The upper portion 12 is positioned vertically above the lower portion 14 with the apertures 44 in the upper body portion 18a axially aligned with the two spacers 42. The upper portion 12 is then moved vertically toward the lower portion 14, so the free ends 52 (FIG. 3A) of the spacers 42 are pressed into the apertures 44 in the upper body portion 18a. The spacers 42 act as guides to keep the upper portion 12 in proper axial and lateral position relative to the lower portion 14, so the line receiving receptacles 30a and 30b remain aligned with each other over the lines 19. The spacers 42 also prevent the upper portion 12 from shifting horizontally relative to the lower portion 14 during the installation and engagement process, thereby keeping the interlocking retention members 54a and 54b substantially vertically aligned with each other.

The upper portion can be moved through an intermediate position (FIG. 3B) between the disengaged and engaged, locked positions (FIGS. 3A and 3C, respectively). In this intermediate position, the interlocking retention members 54a and 54b of the upper and lower body portions 18a and 18b, respectively, engage each other, but are not yet releasably locked together. The upper portion 12 can then be moved vertically and parallel with the lower portion 14 so that the interlocking retention members 54a on opposing sides of the upper body portion 18a contact the retention members 54b on the lower body portion 18b substantially simultaneously. Alternatively, the upper portion 12 can be canted relative to the lower portion 14, as shown in FIG. 3B, so one set of the upper and lower retention members 54a and 54b are approximately in the full engagement position, while upper retention member 54a on the other side of the upper body portion 18a is still positioned above its mating lower retention member 54b.

When the upper and lower portions 12 and 14 are in the intermediate position, with one or both of the upper retention members 54a atop the bottom retention members 54b (FIGS. 3A and 3B), the upper and lower portions 12 and 14 are then pressed together and moved to the engaged, locked position. During such movement, the lower end portion 60 of the upper retention member 54a presses against the sloped camming surface 70 formed by the upper portion of the projecting central portion 68 of the lower retention member 54b. The force on the camming surface 70 causes the lower retention member 54b to flex and bend laterally outwardly about approximately the lower end portion 66 of the lower retention member 54b and away from the upper retention member 54a (and laterally away from the adjacent spacer 42). This engagement between the upper retention member 54a and the camming surface 70 will also cause the lower end portion 60 of the upper retention member 54a to flex and bend laterally inwardly about approximately the central recessed portion 62.

As the upper and lower portions 12 and 14 are pressed together and move further toward the engaged position, the mating upper and lower retention members 54a and 54b continue to flex and move laterally inwardly and outwardly, respectively, until the lower end portion 60 of the upper retention member is laterally inward of the tip of the projecting center portion 68. The mating upper and lower retention members 54a and 54b continue to move vertically into engagement and begin to flex back in the opposite direction. The mating retention members 54a and 54b snap into the engaged, locked position, shown in FIG. 3C, with the projecting central portions 68 of the lower retention members 54b securely positioned in the recessed central portions 62 of the upper retention members 54a. In this engaged, locked position, the upper and lower retention members 54a and 54b hold the upper and lower portions 12 and 14 of the assembly 10 together in firm engagement with the lower end portion 26 and the upper end portion 36 abutting or otherwise adjacent to each other with the lines 19 captured and retained in the aligned line receiving receptacles 30a and 30b. The line block assembly 10 and associated captured lines 19 can then be easily and quickly fastened to the supporting structure of the aircraft, other vehicle, or other supporting structure.

The upper and lower portions 12 and 14 of the line block assembly 10 can be separated and moved to the disengaged position by pulling the upper and lower portions 12 and 14 vertically apart from each other so the mating interlocking retention members 54a and 54b flex laterally until they can pass each other vertically. When the upper and lower portions are in the disengaged position, the lines 19 can be removed, repositioned, or additional lines added to the line block assembly 10.

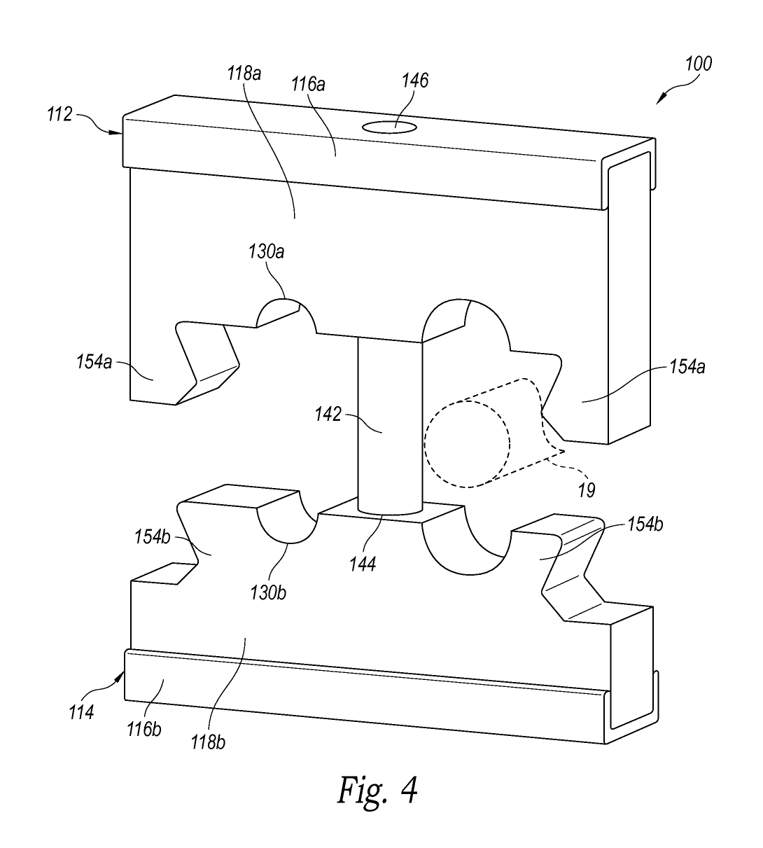

FIG. 4 is an isometric view of a line block assembly 100 in accordance with another embodiment of the present disclosure with upper and lower block support portions 112 and 114 shown in a partially disengaged position. The line block assembly 100 has a configuration similar to the configuration of the line block assembly 10, so much of the detail discussed above also applies to this alternate embodiment, and only the primary differences between the line block assemblies 10 and 100 need be discussed. The line block assembly 100 has the upper and lower portions 112 and 114, respectively, and a single spacer 142 is used between the upper and lower portions. Accordingly, the upper and lower block supports 116a and 116b, respectively, each has only a single aperture 146 that aligns with apertures 144 in the corresponding upper and lower body portions 118a and 118b. While the illustrated embodiment has only a single spacer, other embodiments can have a different number of spacers or other structures that works as an aligning member and/or an anti-compression member.

The illustrated line block assembly 100 also only has two aligned pairs of line-receiving receptacles 130a and 130b in the upper and lower body portions 118a and 118b. The illustrated aligned pairs of line-receiving receptacles 130a and 130b define substantially cylindrical holes of different sizes to snuggly receive lines of different diameters or shapes. Other embodiments can have a different number of line-receiving receptacles (including no line-receiving receptacles) of different shapes and/or sizes.

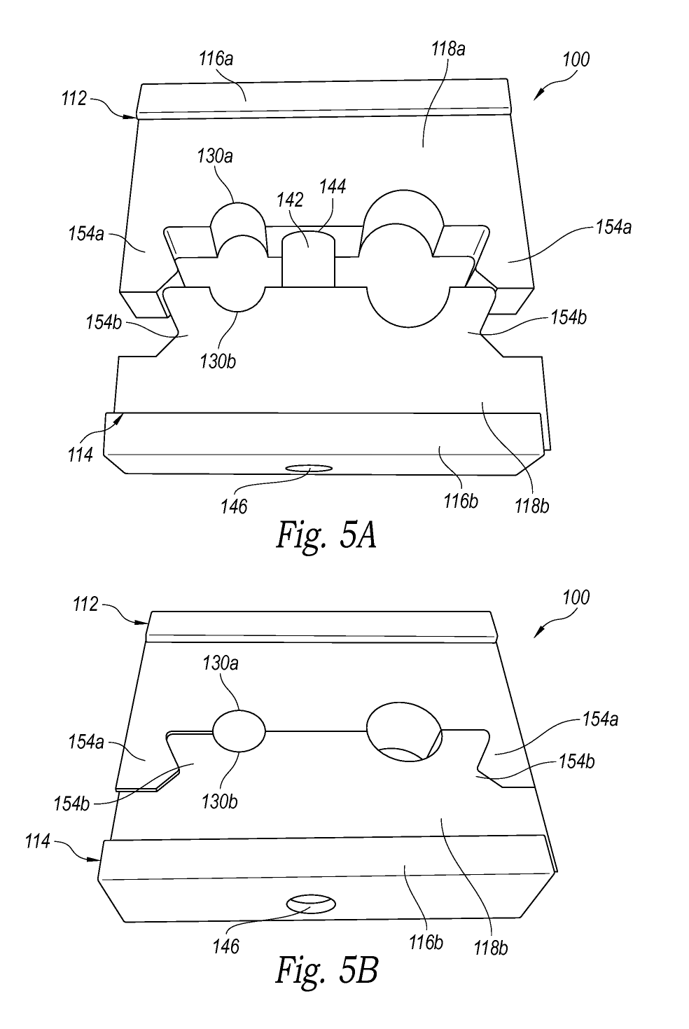

The line block assembly 100 also has the interlocking retention members 154a and 154b in an inverted orientation from the above-discussed line block assembly 10. In this illustrated embodiment, the retention members 154a of the flexible upper body portion 118a define the male portions of the pairs of interlocking retention members, and the retention members 154b of the flexible lower body portion 118b define the female portions of the pairs interlocking retention members. The operation of the interlocking retention members 154a and 154b, however, is substantially the same as discussed above, just inverted, as shown in FIG. 5A (wherein the upper and lower portions 112 and 114 are in the intermediate position) and FIG. 5B (wherein the upper and lower portions 112 and 114 are in the engaged position). In other embodiments, the line block assembly 100 may have an asymmetrical configuration, wherein each of the upper and lower body portions 154a and 154b have a male portion and a female portion of the interlocking retention portions that releasably mate with the corresponding female and male portions of the other lower and upper body portions 154b and 154a.

The line block assembly 110 is configured to allow the upper and lower portions 112 and 114 to be easily and quickly snapped together with the lines 19 captured in the mating line-receiving receptacles in a preassembly arrangement, and the interconnected two halves and captured lines 19 can then be moved as a unit and secured to the support structure via the fastener(s) extending through the spacer 142.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. An interlocking line block assembly, comprising:
a first block portion comprising:
a first outer end surface;
a first inner end surface defining a plurality of concave receptacles;
a plurality of first side surfaces extending between the first inner end surface and the first outer end surface, at least one of the first side surfaces having a first retention member; and
a first aperture extending between the first inner end surface and the first outer end surface, the first aperture spaced apart from the first side surfaces;
a second block portion comprising:
a second outer end surface;
a second inner end surface defining a plurality of concave receptacles;
a plurality of second side surfaces extending between the second inner end surface and the second outer end surface, at least one of the second side surfaces having a second retention member configured to releasably mate with the first retention member of the first block portion, thereby releasably mating the first block portion with the second block portion; and
a second aperture extending between the second inner end surface and the second outer end surface, the second aperture spaced apart from the second side surfaces;
a first block support coupled to the first outer end surface;
a second block support coupled to the second outer end surface; and
a spacer projecting from the second block support, through and beyond the second aperture, the spacer configured to be slidably received within the first aperture when the first block portion is mated with the second block portion.

2. The interlocking line block assembly of claim 1 wherein the assembly is configured such that when the first retention member and the second retention member are mated, the concave receptacles of the first block portion are substantially aligned with the concave receptacles of the second block portion.

3. The interlocking line block assembly of claim 2 wherein the substantially aligned concave receptacles define substantially circular receptacles for receiving lines therethrough.

4. The interlocking line block assembly of claim 1 wherein the spacer is configured so as to engage and block the first block support and the second block support from moving closer to each other than a fixed distance corresponding to a length of the spacer.

5. The interlocking line block assembly of claim 4 wherein the length of the spacer is configured so as to limit a compression force on a line received within the receptacles of the first and second block portions.

6. The interlocking line block assembly of claim 1 wherein the spacer comprises a hollow tube configured to receive a fixation device therethrough for fixing the interlocking line block assembly to a support structure.

7. The interlocking line block assembly of claim 1 further comprising a second spacer spaced apart from and substantially parallel to the first spacer, the second spacer projecting from the second block support and through a third aperture of the second block portion, the second spacer configured to be slidably received within a fourth aperture of the first block portion when the first block portion is mated with the second block portion.

8. The interlocking line block assembly of claim 1 wherein the first block portion and the second block portion comprise a flexible material.

9. The interlocking line block assembly of claim 1 wherein the spacer comprises a rigid tubular member.

10. The interlocking line block assembly of claim 1 wherein the first retention member comprises a recess in the side surface of the first block portion, and the second retention member comprises a corresponding projection in the side surface of the second block portion.

11. The interlocking line block assembly of claim 10 wherein at least one of the first or second retention members is configured to deflect during mating of the first retention member with the second retention member.

12. An interlocking line block assembly, comprising:
an upper portion comprising:
an upper support member;
an upper flexible body projecting from the upper support member, the upper flexible body comprising an upper retention member and an upper line-receiving receptacle; and
an aperture extending through the upper flexible body;
a lower portion comprising:
a lower support member;
a lower flexible body projecting from the lower support member, the lower flexible body comprising a lower retention member configured to mate with the upper retention member, and a lower line-receiving receptacle; and
a spacer projecting from the lower support member, the spacer configured to be slidably received within the aperture of the upper flexible body when the upper retention member is mated with the lower retention member.

13. The interlocking line block assembly of claim 12 wherein the assembly is configured such that when the upper retention member and the lower retention member are mated, the upper line-receiving receptacle is substantially aligned with the lower line-receiving receptacle.

14. The interlocking line block assembly of claim 12 wherein the spacer is configured so as to engage and block the upper support member and the lower support member from moving closer to each other than a fixed distance corresponding to a length of the spacer.

15. The interlocking line block assembly of claim 12 wherein the upper retention member comprises a recess in the upper flexible body, and the lower retention member comprises a corresponding projection in the lower flexible body that releasably engages with the recess in the upper flexible body and holds the upper and lower flexible bodies together.

16. The interlocking line block assembly of claim 15 wherein at least one of the upper and lower retention members is configured to deflect during mating of the upper retention member with the lower retention member.

17. An interlocking line block assembly, comprising:
a first block portion comprising:
a first support member; and
a first flexible body projecting from the first support member, the first flexible body comprising a first line-engaging portion spaced apart from the first support member, and the first flexible body comprising a male retention member;
a second block portion separably connectable to the first block portion and comprising:
a second support member spaced apart from the first support member;
a second flexible body projecting from the second support member and being aligned and substantially co-planar with the first flexible body, wherein the first and second body portions are positioned between the first and second support members, the second flexible body comprising a second line-engaging portion spaced apart from the second support member and being positionable immediately adjacent to the first line engage portion of the first flexible body portion, the second flexible body comprising a female retention member configured to mate with the male retention member to releasably hold the first and second flexible body portions together; and
a spacer connected to the first and second block portions and extending between the first and second support members, the spacer being sized to block the first and second support members from moving closer to each other than a fixed distance corresponding to a length of the spacer thereby limiting a compression force between the first and second flexible body portions when the male and female retention members are releasably engaged with each other.

18. The interlocking line block assembly of claim 17 wherein male retention member of the first flexible body is a first male retention member, and the first flexible body has one of a second male or second female retention member spaced apart from the first male retention member, and wherein the female retention member of the second flexible body is a first female retention member, and the second flexible body has the other one of the second male or female retention member that mates with the one of the second male or second female retention members of the first flexible body.

19. The interlocking line block assembly of claim 17 wherein the spacer is a rigid spacer configured to engage the first and second support members with the first and second flexible body portions therebetween.

20. The interlocking line block assembly of claim 17 wherein at least one of the first or second line engaging portions comprises at least one recess therein configured to retain a line extending therethrough when the first and second block portions are mated together.

21. The interlocking line block assembly of claim 17 wherein at least one of the male or female retention members are deflectable and configured to deflect during mating of the first and second flexible body portions.

22. The interlocking block assembly of claim 17 wherein the first and second flexible body portions have axially aligned apertures therein, and the spacer is positioned in the axially aligned apertures.

23. A method of retaining a line in an interlocking line block assembly, the method comprising:
providing a first block portion comprising:
a first support member;
a first flexible body projecting from the first support member, the first flexible body comprising a first retention member and a first line-receiving receptacle; and
an aperture extending through the first flexible body;
providing a second block portion comprising:
a second support member;
a second flexible body projecting from the second support member, the second flexible body comprising a second retention member and a lower line-receiving receptacle; and
a spacer projecting from the second support member;
disposing the line within the first line-receiving receptacle; and
mating the first block portion with the second block portion such that the second line-receiving receptacle engages the line disposed within the first line-receiving receptacle, wherein the spacer is slidably received within the aperture of the first flexible body and the first retention member is releasably mated with the second retention member.

24. The method of claim 23, further comprising fixing the spacer to the first support member.

25. The method of claim 23 wherein mating the first block portion with the second block portion comprises deflecting at least one of the first retention member and the second retention member.
